(19) United States
(12) Patent Application Publication
(10) Pub. No.: US 2007/0222739 A1
(43) Pub. Date: Sep. 27, 2007

(54) DRIVING CIRCUIT WITH PROTECTION MODULE FOR BACK LIGHT MODULE

(76) Inventors: Chung-Che Yu, Taipei (TW); Li-Min Lee, Taipei (TW); Chin-Fa Kao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,019

(22) Filed: Jun. 9, 2006

(30) Foreign Application Priority Data
Mar. 22, 2006 (TW) 95109796

(51) Int. Cl. G09G 3/36

(52) U.S. Cl. 345/102

(57) ABSTRACT

A driving circuit for a plurality of light-emitting diodes (LEDs) comprises a transformer, a driving module, and a protection module. The transformer has a primary coil and a secondary coil, wherein a first end of the primary coil is coupled to a voltage source. Furthermore, a second end of the primary coil of the transformer is coupled to the driving module. The driving module determines whether to deliver electrical power to the transformer according to a pulse-width modulation (PWM) signal and an error signal. The protection module is coupled to the secondary coil. When a driving voltage output by the transformer to the LEDs is less than a first preset voltage or greater than a second preset voltage, the protection module generates the error signal to the driving module.

### CROSS-REFERENCE TO RELATED APPLICATION

This application claims the priority benefit of Taiwan application serial no. 95109796, filed on Mar. 22, 2006. All disclosure of the Taiwan application is incorporated herein by reference.

### BACKGROUND OF THE INVENTION

1. Field of Invention

The present invention relates to a driving technology for a plurality of light-emitting diodes (LEDs). More particularly, the present invention relates to a driving technology for LEDs used in a back light module.

2. Description of Related Art

In a conventional back light module, a cold cathode fluorescent tube is commonly used as a light source. However, in recent years, with the advance of the photoelectric element technique, a light-emitting diode has many advantages, such as small size, low operating voltage, long lifespan and high color saturation. Therefore, using LEDs as the light source of the back light module has become another new choice.

Due to a factor of manufacturing process, even the LEDs on the same wafer have different electrical properties, the brightnesses of LEDs in parallel are quite different in practical application. To promote manufacturing process' yield and reduce the manufacturing cost, the LEDs used in the current LED back light module mostly use the series-connected LEDs as the light source, such that the current flowing through each LED is equal and thus the brightness is substantially identical.

FIG. 1 is a circuit diagram of a conventional LED back light module. Referring to FIG. 1, in the conventional LED back light module, a plurality of series-connected LEDs 101 is used as the light source, and is grounded via a resistor 103.

Referring to FIG. 1, to reduce variation in the brightness of the LEDs 101 with elapsing time, a pulse-width modulation (PWM) controller 105 is disposed in the back light module for generating a PWM signal Vpwm to control the brightness of the LEDs 101. In the conventional back light module, the PWM controller 105 delivers the PWM signal Vpwm to the gate of an NMOS transistor 107. The drain end of the NMOS transistor 107 is coupled to a voltage source VDD via an inductor 109 and the series-connected LEDs 101 via a Schottky diode 111, and a capacitor 113. Furthermore, the source of the NMOS transistor 107 and the other end of the capacitor 113 are grounded.

Furthermore, the PWM controller 105 is also coupled to a node where the LEDs 101 and the resistor 103 to detect current of the LEDs 101. Thus, the PWM controller 105 determines duty cycle of the PWM signal Vpwm according to a detected result so as to modulate the brightness of the LEDs 101.

A boost circuit as shown in FIG. 1 generates an output DC voltage Vout higher than the voltage source VDD to drive each LED 101. However, as the dimension of a flat panel display become larger, the dimension of the back light module also needs to be increased accordingly, such that more and more LEDs 101 are required and the required driving voltage also becomes higher. The boost magnification (Vout/VDD) provided by the boost circuit in FIG. 1 is not high enough to provide such a high driving voltage. Therefore, the design of using the inductor 109 as a boost element is certainly limited by value of the voltage source VDD, such that the requirement for continuously adding series-connected LEDs 101 cannot be more flexibly satisfied.

Furthermore, due to the increase of the number of the series-connected LEDs 101, driving voltage thereof also increases so as to have the requirement for over voltage protection. The current LED back light module only uses the Schottky diode to clamp the driving voltage below a certain voltage value. However, when the driving voltage is higher, the Schottky diode with a higher breakdown voltage is necessary. Thus, not only is the cost of elements increased, but also the high voltage is output continuously without over voltage protection when the output voltage is over, such that other elements could be damaged.

### SUMMARY OF THE INVENTION

Therefore, the present invention provides a circuit for driving the LEDs, which may drive a plurality of series-connected LEDs and thus may be applied in many display panels with different dimensions.

The driving circuit for the LEDs provided by the present invention also has a preferred protection module, which may prevent the driving circuit of the present invention from outputting a too high or too low driving voltage.

The driving circuit for the LEDs provided by the present invention comprises a transformer, a driving module, and a protection module. The transformer comprises a primary coil and a secondary coil. In the present invention, a first end of the primary coil is coupled to a voltage source, a first end of the secondary coil is coupled to the LEDs, and a second end of the secondary coil is grounded. Furthermore, the second end of the primary coil of the transformer is coupled to the driving module, and the driving module determines whether to deliver electrical power to the transformer according to a PWM signal and an error signal. The protection module is coupled to the secondary coil. When a driving voltage output by the transformer to the LEDs is less than a first preset voltage or greater than a second preset voltage, the protection module generates the error signal to the driving module, so as to stop the output of the electrical power.

In an embodiment of the present invention, the above-mentioned protection module comprises a first comparator, a first timer, and an initial timer. The first comparator is used to determine whether the driving voltage is lower than a first preset voltage and output a first compared result. The first timer is used to receive the first compared result and generate a first timing signal when the driving voltage is less than the first preset voltage for a first preset time. In the present invention, the first timer is in a disabled state until the driving circuit is activated for a period of time. Furthermore, the initial timer is used to generate an initial timing signal to enable the first timer when the driving circuit is activated for the period of time. A first timing value output by the first timer is delivered to a latch, and then output to the driving module after being delivered to an inverter via the latch.

Furthermore, the protection module further comprises a second comparator and a second timer. The second comparator is used to determine whether the driving voltage is higher than a second preset voltage and output a second compared result. The second timer is used to receive the second compared result and generate a second timing signal when the driving voltage is greater than the second preset voltage for a second preset time. The second timing signal is delivered to an OR gate. The OR gate not only receives the second timing signal, but also receives the first timing signal. Furthermore, the output of the OR gate is delivered to the latch.

In some other alternative embodiments, the above-mentioned second comparator compares the driving voltage with the second preset voltages, wherein the second comparator has high hysteresis. When the driving voltage is greater than the second preset voltage by more than one hysteresis voltage, the second comparator generates an output of high level to the OR gate. This OR gate receives the output of the above-mentioned latch, and the output of this OR gate is delivered to the above-mentioned inverter.

The back light module provided by the present invention comprises a light source module. Furthermore, the back light module of the present invention is driven by the above-mentioned driving circuit to emit light.

Since the present invention uses the transformer to transform the voltage source into the driving voltage to drive the light source, the present invention could adjust value of the driving voltage according to the number of series-connected LEDs without any limitation. Therefore, the present invention is more flexible in application.

In order to the make aforementioned and other objects, features and advantages of the present invention comprehensible, a preferred embodiment accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

FIG. 1 is a circuit diagram of a conventional LED back light module.

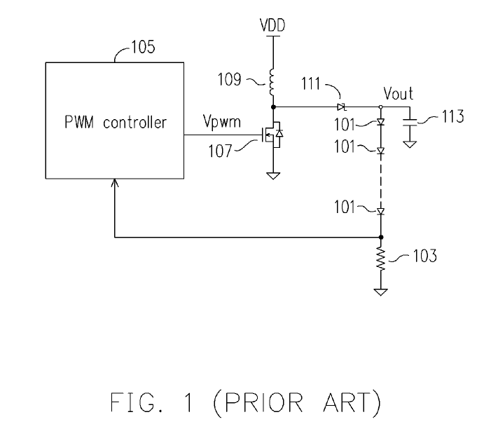

FIG. 2A is a circuit diagram of a back light module according to the first embodiment of the present invention.

FIG. 2B is a circuit diagram of a back light module implementing a protection circuit of the present invention.

FIG. 3 is a circuit diagram of a back light module according to the second embodiment of the present invention.

FIG. 4 is a circuit diagram of a back light module according to the third embodiment of the present invention.

FIG. 5 is a timing diagram of a dimming signal and a PWM signal according to a preferred embodiment of the present invention.

### DESCRIPTION OF EMBODIMENTS

The preferred embodiments of the present invention will be illustrated in detail below with reference to appended drawings, wherein the appended drawings show various preferred embodiments of the present invention. The present invention can also be accomplished by many different ways, and is not limited to the embodiments described herein. The object of providing embodiments herein is to make those skilled in the related art fully comprehend the scope of the present invention. In the following part, similar reference numbers represent similar elements.

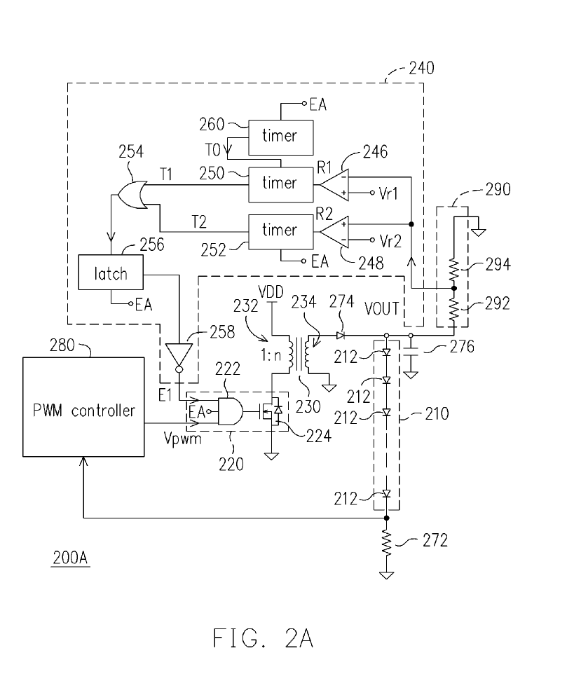

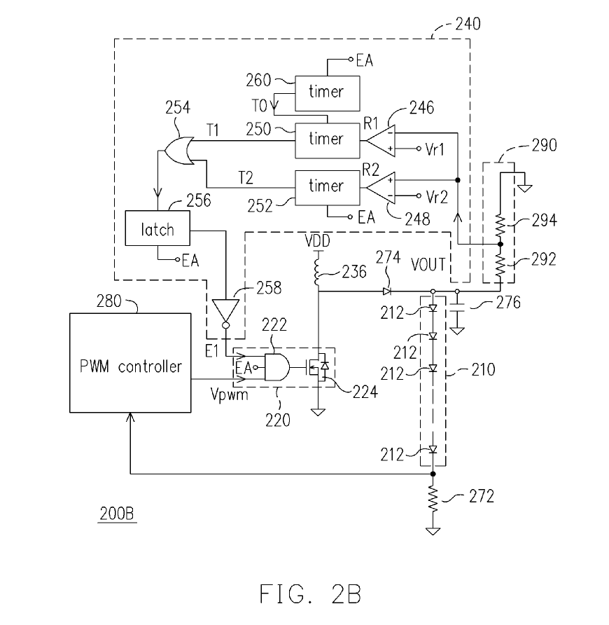

FIG. 2A is a circuit diagram of a back light module according to a first embodiment of the present invention. Referring to FIG. 2A, a back light module 200A provided by the present invention comprises a light source module 210 and a driving circuit constituted by a driving module 220, a transformer 230, and a protection module 240. In the embodiment of the present invention, the light source module 210 may be formed by a plurality of series-connected LEDs 212. The transformer 230 is implemented in a booster that is capable of magnifying a driving voltage source so as to provide a higher DC driving voltage to drive more LEDs in series.

In particular, the cathode end of each LED 212 is coupled to the anode end of next LED 212, and the last LED 212 is coupled to the ground via a resistor 272. Those skilled in the art should understand that the LEDs 212 in the back light module 200A can include white light LEDs, red light LEDs, blue light LEDs and green light LEDs.

Referring to FIG. 2A, the transformer 230 has a primary coil 232 and a secondary coil 234 with a proportion of 1/n. In the present embodiment, a first end of the primary coil 232 is coupled to a voltage source VDD, and a second end thereof is coupled to the driving module 220. Furthermore, a first end of the secondary coil 234 is coupled to the light source module 210 via a diode 274, for example, coupled to the anode end of the first LED 212, while a second end of the secondary coil 234 is grounded. In a preferred situation, the diode 274 can be accomplished by a Schottky diode.

The first end of the secondary coil 234 is also coupled to the protection module 240 in addition to the light source module 210, and is coupled to the ground via a capacitor 276. The output of the protection module 240 is delivered to the driving module 220, such that the driving module 220 determines whether to stop outputting electrical power of the voltage source VDD to the transformer 230 according to the output of the protection module 240.

The driving module 220 may include an AND gate 222 and an NMOS transistor 224. The AND gate 222 receives a PWM signal Vpwm and the output of the protection module 240. Furthermore, the output of the AND gate is coupled to the gate end of the NMOS transistor 224, and the drain of the NMOS transistor 224 is coupled to the second end of the primary coil 232, and the source thereof is grounded. In the embodiment of the present invention, the AND gate can also receive an activation control signal EA (also called an error reset signal). The activation control signal EA is also output to a first timer 252, a second timer 260, and a latch 256 at the same time. Before being activated or when being restarted, a signal of EA=0 is output to the back light module 200Asuch that the NMOS transistor 224, the first timer 252, the second timer 260, and the latch 256 are reset. After the back light module 200A is activated or restarted, EA=1, so as to activate the NMOS transistor 224, the first timer 252, the second timer 260 and the latch 256.

In the present embodiment, the PWM signal Vpwm may be generated by a PWM controller 280. Furthermore, the PWM controller 280 detects the voltage of a node where the light source module 210 and the resistor 272, that is, detects the current flowing through the light source module 210. Thus, the PWM controller 280 can control duty cycle of the PWM signal Vpwm according to the detected signal of the light source module 210, such that the light source module 210 has stable brightness. Of course, the PWM controller 280 can also generate the PWM signal Vpwm according to the detected signal (for example, coupled to the voltage detection module 290) of the voltage of the light source module 210.

The voltage detection module 290 includes resistors 292 and 294 in series, wherein a first end of the resistor 292 is coupled to the cathode end of the diode 274, and is coupled to the first end of the secondary coil 234 via the diode 274. Furthermore, a second end of the resistor 292 is coupled to an inverting input of a comparator 246 and a non-inverting input of a comparator 248. The driving module 220, the protection module 240, the PWM controller 280, and the voltage detection module 290 can be integrated in an integrated circuit chip. Alternatively, the voltage detection module 290 could be independent of the integrated circuit chip, such that the designer of the back light module can allocate the proportion of the resistors 292 and 294 more freely to match various back light modules.

Furthermore, the non-inverting input of the comparator 246 receives a preset voltage Vr1, and the inverting input of the comparator 248 receives a preset voltage Vr2. Thereby, the comparator 246 compares the driving voltage VOUT with the preset voltage Vr1, and generates a compared result R1 to the timer 250. Similarly, the comparator 248 compares the driving voltage VOUT with the preset voltage Vr2, and generates a compared result R2 to the timer 252. In the present embodiment, the comparators 246 and 248 are respectively used to detect whether the driving voltage VOUT becomes too low or too high, and thus the preset voltage Vr1 is lower than the preset voltage Vr2.

Next, the operating process of the back light module 200A is illustrated below.

When the back light module 200A is just activated, the error reset signal EA is in a high level state (i.e. EA=1). To avoid a situation that the back light module 200A of the present invention is regarded as an error due to a too low driving voltage VOUT when just being started, a timer 260 is disposed in the protection module 240. When the back light module 200A is just started, the timer 260 outputs a low level signal of T0=0 and begins timing. Here, the timer 250 receives the low level signal of T0=0 to be in a disabled state, so at this time, T1=0.

Furthermore, the timer 252 is activated by receiving EA=1. At this time, as the driving voltage VOUT is lower than the preset voltage Vr2 and the comparator 248 outputs R2=0, the timer 252 outputs T2=0. Therefore, an OR gate 254 outputs a low level signal after receiving T1=0 and T2=0. After receiving EA=1 and being activated, the latch 256 receives the low level signal of the OR gate 254 and also outputs a low level signal, and then an inverter 258 outputs a high level signal of E1=1. Thus, when the back light module 200A is just activated, EA=1 and E1=1. The AND gate 222 generates the PWM signal Vpwm to control turning on-off of the NMOS transistor 224 according to the PWM controller 280, and the transformer 230 can transform the voltage source VDD into the driving voltage VOUT to drive the light source module 210.

After the timer 260 times to a first preset time, if the EA still remains as a high level signal of “1”, the timer 260 outputs a high level signal of T0=1. Thus, the timer 250 receives the signal of T0=1 and begins operating. The preferred first preset time of the timer 260 is equal to or longer than the period required for activating the back light module 200A. After the first preset time, the light source module 210 begins to operate normally. Therefore, when the timer 250 starts to operate, the voltage detection module 290 outputs a detected signal that is greater than the preset voltage Vr1 and lower than the preset voltage Vr2. Thus, after entering a normal operation state, the output signals R1 and R2 of the comparators 246 and 248 are both low level signals, such that the output signals T1 and T2 of the timers 250 and 252 are also low level signals. Therefore, under normal activation, the latch 256 continues outputting low level signals to make the signal E1 remain at a low logic level “0”.

However, when the driving voltage VOUT is too low due to activation failure or other errors, for example, when a user carelessly touches the end of the secondary coil 234 of the transformer 230, the driving voltage VOUT discharges via the discharging path from human body to the ground. At this time, the driving voltage VOUT is lower than the preset voltage Vr1, and the comparator 246 outputs an output signal R1 of high level to the timer 250, such that the timer 250 starts to count time.

When the driving voltage VOUT is lower than the preset voltage Vr1 for a second preset time, the timer 250 generates a timing signal T1 of high level to the OR gate 254. Thus, the OR gate 254 delivers an output of high level to the latch 256. The latch 256 outputs and latches an output signal in high level, and then the inverter 258 generates an error signal E1 of low level to the AND gate 222. The transistor 224 is turned off , so as to stop supplying the electrical power of the voltage source VDD to the transformer 230. The present invention can provide the driving voltage VOUT to the light source module 210 again only after the reason of activation failure or other errors is eliminated and the user re-activates the back light module 200A to make the error reset signal EA=0 to reset the AND gate 222, the timer 252, the timer 260 and the latch 256.

On the other hand, however, when some error states result in a too high driving voltage VOUT, the comparator 248 of the protection module 240 detects the phenomenon that the driving voltage VOUT becomes too high. Here, when the driving voltage VOUT is greater than the preset voltage Vr2, the comparator 248 generates an output of high level to the timer 252 so as to make the timer 252 begin timing. When the driving voltage VOUT is greater than the preset voltage Vr2 for a third preset time, the timer 252 generates a timing signal T2 of high level to the OR gate 254, and further the OR gate 254 delivers an output of high level to the latch 256. After that, the latch 256 outputs and latches an output signal in high level, and then the inverter 254 generates an error signal E1 of low level to the AND gate 222. Therefore, the transistor 224 may also be turned off, thus making the voltage source VDD unable to supply the electrical power to the transformer 230. Similarly, the present invention can provide the driving voltage VOUT to the light source module 210 again only after the high voltage event is eliminated and the user re-activates the back light module 200A to make the error reset signal EA=0 to reset the AND gate 222, the timer 252, the timer 260 and the latch 256.

It may be seen from the above description that, after the timer 260 passes the first preset time, the protection module 240 begins to perform the protecting function. As long as the driving voltage VOUT becomes too low or too high, the protection module 240 controls and latches the driving module 220 in an operation-stop state, such that the voltage source VDD cannot supply the electrical power to the light source module via the transformer 230. The back light module 200A maintains the output stop state unless the user re-activates the back light module 200A, and the back light module 200A cannot be normally activated until the error event is eliminated.

Of course, the signal T0 of the timer 260 of the present invention can also be directly input into the latch 256, rather than the timer 250. Thus the latch 256 starts to operate only after the signal T0 changes from 0 to 1 in the activating process. Similarly, the situation that the back light module 200A is regarded as an error due to a too low driving voltage VOUT when just being started, can also be avoided as the above description.

In other alternative embodiments, the protection circuit of the present invention is not only used in the back light module boosted by the transformer, but also used in the conventional boost circuit. For example in FIG. 2B, the transformer is replaced by an inductor 236. The protection circuit 240 detects the driving voltage VOUT via the voltage detection module 290. When the driving voltage VOUT becomes too high or too low, the timer 252 or 250 begins to count time. If the voltage continues to be too high or too low after a preset time, the output of the electrical power of the power source VDD is stopped and latched. After the output of the power source VDD is stopped and latched, the back light module 200B must be re-activated, such that the low level signal of EA=0 resets the protection circuit 240 and the driving circuit 220, thus the back light module 200B is able to operate again.

Furthermore, the error reset signal EA in the present invention is a control signal which can stop the action of the back light module without stopping the power supply of a system. The error reset signal EA is used to reset the back light module to be activated again when the back light module is latched because of the error state. In addition, the system comprising the back light module can use the error reset signal EA to control the back light module to be activated at a suitable time. As such, the system can arrange activating time for the back light module and other devices in the system, thereby reducing interference between each other or achieving a preferred activating sequence.

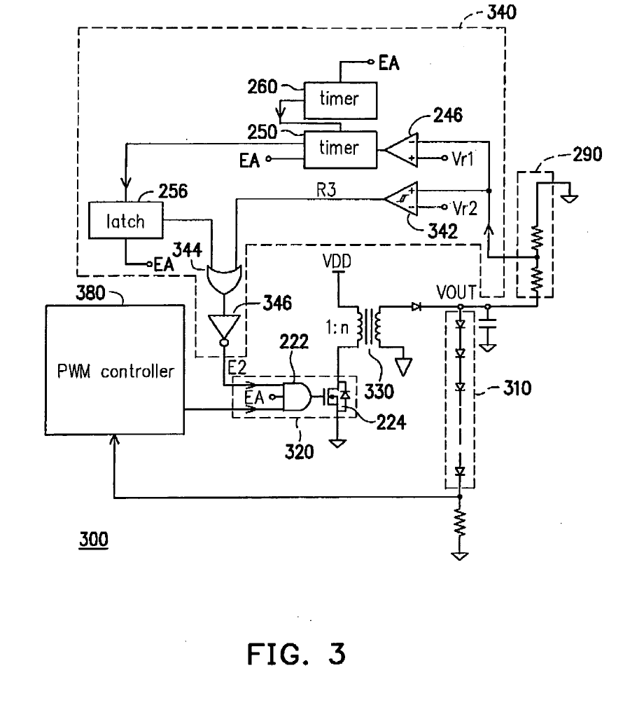

FIG. 3 is a circuit diagram of a back light module according to a second embodiment of the present invention. Referring to FIG. 3, the back light module 300 being substantially similar to the back light module 200A provided by the first embodiment has a light source module 310, a PWM controller 380, a driving module 320, a transformer 330 and a protection module 340. Those skilled in the art can refer to the description related to the light source module 210, PWM controller 280, driving module 220, transformer 230 and protection module 240 in the first embodiment in order to understand the coupling relations and operating principles of these means.

However, the difference is that, in the protection module 340, a hysteresis comparator 342 with high hysteresis value is used to replace the comparator 248 in the first embodiment. In the present embodiment, the hysteresis comparator 342 also compares the detected signal of the driving voltage Vout with the preset voltage Vr2. However, when the detected signal is greater than the preset voltage Vr2 by a hysteresis voltage (of the comparator 342), the hysteresis comparator 342 generates an output R3 of high level. Therefore, in the present embodiment, the protection module 340 can reduce the number of timers by one (i.e.: the timer 252 could be omitted).

When the detected signal is greater than the preset voltage Vr2 by more than one hysteresis voltage, the hysteresis comparator 342 generates an output R3 of high level to an OR gate 344. Another input end of the OR gate 344 is used to receive the output of the latch 256. Thus, when the hysteresis comparator 342 generates the output R3 of high level, the output R3 is delivered to the inverter 346 via the OR gate 344, and generates an error signal E2 of low level to the AND gate 222 after being inverted by the inverter 346. Particularly, as the output of the hysteresis comparator 342 does not pass through the latch, the back light module 300 is re-activated automatically as long as the voltage of the driving voltage Vout recovers to its normal state to make the hysteresis comparator 342 output the output R3 of low level again, and there is no need for the user to manually enable the error reset signal EA.

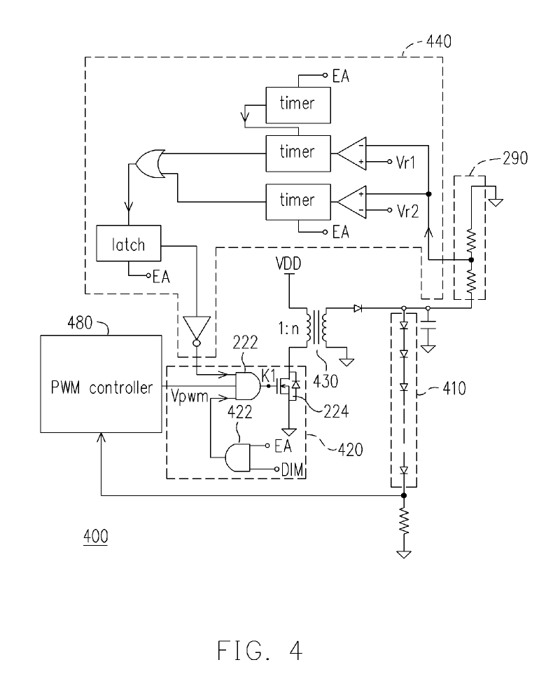

FIG. 4 is a circuit diagram of a back light module according to a third embodiment of the present invention. Referring to FIG. 4, a back light module 400 provided by the present embodiment is generally the same as the back light module 200A provided by the first embodiment, and has a light source module 410, a PWM controller 480, a driving module 420, a transformer 430, and a protection module 440. Those skilled in the art can refer to the description related to the light source module 210, PWM controller 280, driving module 220, transformer 230, and protection module 240 in the first embodiment to understand the coupling relationships and operating principles of these means.

The difference from the first embodiment is that, the driving module 420 additionally receives a dimming signal DIM, such that the back light module 400 has a dimming function. In the present embodiment, the driving module 420 includes an AND gate 222, an NMOS transistor 224, and an AND gate 422. The AND gate 422 is used to receive the error reset signal EA and the dimming signal DIM. The frequency of the dimming signal DIM is lower than that of the PWM signal Vpwm. The turning on-off of the driving module 420 can be controlled by controlling the duty cycle of the dimming signal DIM so as to achieve the effect of light modulation.

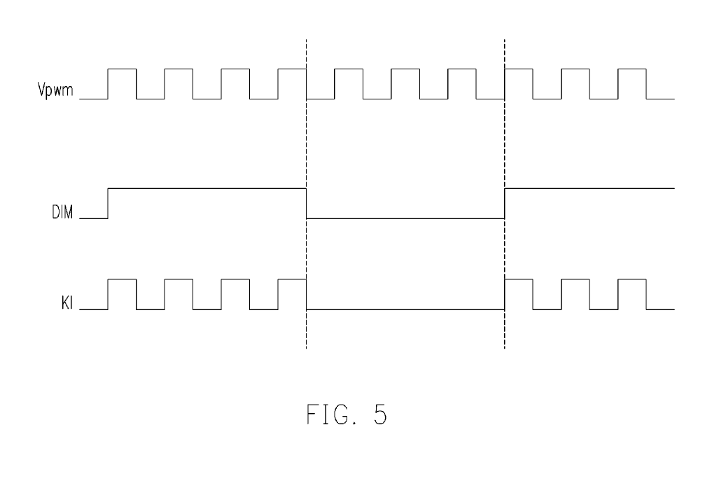

FIG. 5 is a timing diagram of a dimming signal and a PWM signal according to a preferred embodiment of the present invention. Referring to FIG. 4 and FIG. 5 concurrently, in the present embodiment, when the brightness of the light source module 410 is required to be tuned down, it is only need to deliver the dimming signal DIM (as shown in FIG. 5) with a frequency relatively lower than that of the PWM signal Vpwm to the input end of the AND gate 422. Then, the AND gate 222 can perform the “AND” operation of the PWM signal Vpwm and the dimming signal DIM. Thus, a signal K1 is output to a gate of the transistor 224 to turn down the brightness of the light source module 410. On the contrary, when the brightness of the light source module 410 is required to be raised, it is only necessary to generate a dimming signal DIM with a larger duty cycle to the input end of the AND gate 422.

In view of the above, the present invention at least has the following advantages:

1. As the present invention adopts a transformer to generate a driving voltage, the present invention can provide a driving voltage with a larger multiple to drive the light source, and thus the driving circuit provided by the present invention is suitable to be used in back light modules of different dimensions.

2. As the present invention adopts a transformer to generate a driving voltage, the present invention can not only generate the driving voltage by boost, but by buck as well, such that the present invention is more flexible in use.

3. As the present invention has a protection module, the protection module can protect the operation of the light source under a too low or a too high voltage.

4. The present invention can also have a dimming mechanism, such that the user can modulate the brightness of the back light module according to the practical requirements.

Though the present invention has been disclosed above by the preferred embodiments, they are not intended to limit the invention. Anybody skilled in the art can make some modifications and variations without departing from the spirit and scope of the invention. Therefore, the protecting range of the invention falls in the appended claims.

What is claimed is:

1. A driving circuit of light-emitting diodes (LEDs), comprising:
a transformer, comprising a primary coil and a secondary coil, wherein a first end of the primary coil is coupled to a voltage source, a first end of the secondary coil is coupled to the series-connected LEDs, and a second end of the secondary coil is grounded;
a pulse-width modulation (PWM) controller, used to generate a PWM signal according to a detected signal of the LEDs; and
a driving module, coupled to a second end of the primary coil of the transformer and delivering electrical power to the transformer according to the PWM signal.

2. The driving circuit of LEDs as claimed in claim 1, further comprising a protection module coupled to the transformer and used to generate an error signal to the driving module when a driving voltage output by the transformer to the LEDs is less than a first voltage or greater than a second voltage, wherein the driving module stops delivering the electrical power to the transformer according to the error signal.

3. The driving circuit of LEDs as claimed in claim 2, wherein the driving module comprises:
an AND gate, used to receive the PWM signal and the error signal; and
an NMOS transistor, comprising a gate coupled to the output of the AND gate, a drain coupled to the second end of the primary coil and a grounded source.

4. The driving circuit of LEDs as claimed in claim 3, wherein the driving module further receives a dimming signal for modulating the brightness of the LEDs, wherein the frequency of the dimming signal is different from that of the PWM signal.

5. The driving circuit of LEDs as claimed in claim 2, further comprising a voltage detection module for generating a voltage detection signal according to the driving voltage.

6. The driving circuit of LEDs as claimed in claim 5, wherein the protection module comprises:
a first comparator, used to compare the voltage detection signal with a first preset voltage, so as to determine whether the driving voltage is less than the first voltage and then output a first compared result;
a first timer, receiving the first compared result and generating a first timing signal when the driving voltage is less than the first preset voltage for a first preset time; and
a latch, receiving the first timing signal.

7. The driving circuit of LEDs as claimed in claim 6, wherein the protection module further comprises an initial timer that does not generate an initial timing signal to activate the first timer after the driving circuit is activated for a period of time.

8. The driving circuit of LEDs as claimed in claim 6, wherein the protection module further comprises:
a second comparator, used to compare the voltage detection signal with a second preset voltage, so as to determine whether the driving voltage is greater than the second voltage and then output a second compared result;
a second timer, receiving the second compared result and generating a second timing signal when the driving voltage is greater than the second voltage for a second preset time; and
an OR gate, receiving the first timing signal and the second timing signal, and delivering the output to the latch.

9. The driving circuit of LEDs as claimed in claim 6, wherein the protection module further comprises:
a hysteresis second comparator, used to compare the voltage detection signal with a second preset voltage, and outputting a second timing signal according to the comparative result; and
an OR gate, receiving an output signal of the latch and the second timing signal.

10. The driving circuit of LEDs as claimed in claim 6, wherein the protection module further comprises an inverter used to generate the error signal by inverting the output of the latch.

11. The driving circuit of LEDs as claimed in claim 8, wherein the protection module further comprises an inverter used to generate the error signal after inverting the output of the OR gate.

12. The driving circuit of LEDs as claimed in claim 9, wherein the protection module further comprises an inverter used to generate the error signal after inverting the output of the OR gate.

13. A back light module, comprising:
a light source module;
a booster, coupled to a voltage source and the light source module for generating a DC driving voltage to drive the light source module;
a protection module, coupled to the booster for generating an error signal when the driving voltage is greater than a first preset voltage;
a PWM controller, generating a PWM signal according to a detected signal of the light source module; and
a driving module, comprising:
an AND gate, for receiving the PWM signal and the error signal; and
an NMOS transistor, comprising a gate coupled to an output of the AND gate, a drain coupled to the booster and a grounded source, wherein the driving module stops outputting electrical power to the light source module according to the error signal.

14. The back light module as claimed in claim 13, wherein the driving module further receives a dimming signal for modulating the brightness of the light source module, wherein the frequency of the dimming signal is different from that of the PWM signal.

15. The back light module as claimed in claim 13, wherein the protection module generates the error signal after the driving voltage is greater than the first preset voltage for a period of time.

16. The back light module as claimed in claim 15, wherein the protection module comprises a latch for continuously generating the error signal after the driving voltage is greater than the first preset voltage for the period of time.

17. The back light module as claimed in claim 14, wherein the latch is coupled to a reset signal to determine whether or not to release from the latching state.

18. The back light module as claimed in claim 13, wherein the driving module is coupled to a reset signal to determine whether to output electrical power to the light source module.

19. The back light module as claimed in claim 13, further comprising a voltage detection module to generate a voltage detection signal according to the driving voltage, wherein the protection module is coupled to the booster to determine whether the driving voltage is greater than the first preset voltage according to the voltage detection signal.

20. The back light module as claimed in claim 19, wherein the voltage detection module comprises two resistors in series.

21. The back light module as claimed in claim 13, wherein the protection module further generates the error signal when the driving voltage is smaller than a second preset voltage.

22. The back light module as claimed in claim 13, wherein the protection module further generates the error signal after the driving voltage is smaller than the second preset voltage for a period of time.

23. The back light module as claimed in claim 22, wherein the protection module fbrther comprises a latch for latching the error signal after the driving voltage is smaller than the second preset voltage for the period of time.
